(19) United States
(12) Patent Application Publication
(10) Pub. No.: US 2011/0275738 A1
(43) Pub. Date: Nov. 10, 2011

(54) PROCESS FOR PRODUCING FINELY DIVIDED SUSPENSIONS BY MELT EMULSIFICATION

(75) Inventors: Robert ENGEL, Speyer (DE); Thomas Danner, Weinheim (DE); Bernd Sachweh, Meckenheim (DE); Sonja Judat, Ludwigshafen (DE); Andreas Bauder, Mannheim (DE); Nikolai Denkov, Sofia (BG); Slavka Tcholakova, Sof (BG)

(73) Assignee: BASF SE, Ludwigshafen (DE)

(21) Appl. No.: 13/100,500

(22) Filed: May 4, 2011

Related U.S. Application Data
(60) Provisional application No. 61/331,406, filed on May 5, 2010.

(51) Int. Cl. C08J 3/22; C09K 3/00

(52) U.S. Cl. 523/351; 252/182.12

(57) ABSTRACT

The invention relates to a process for the preparation of finely divided suspensions by melt emulsification, comprising at least one substance with a melting temperature above room temperature, comprising the following steps:

(a) passing at least one preemulsion, comprising one continuous phase and one disperse phase, to a rotor-stator machine, a rotor-rotor machine or to a continuous and/or disperse phase;

(b) optionally adding one or more further components to the at least one preemulsion in the rotor-stator machine;

(c) emulsifying the at least one preemulsion with mechanical shear and/or elongation and/or turbulence at a temperature which is at most 10 K above the melting temperature of the at least one substance with a melting temperature above room temperature, or at a temperature which is at least 10 K below and at most 10 K above the glass transition temperature or the melting temperature, if the substance with a melting temperature above room temperature is a polymer, for producing a finely divided emulsion;

(d) cooling the finely divided emulsion to produce a finely divided suspension;

where the disperse phase fraction at least in step (c) is in the range from 85% to 99.5%.

The present invention relates to a process for producing finely divided suspensions by melt emulsification of a substance with a melting temperature above room temperature. In addition, the invention relates to a process for producing finely divided suspensions for producing dispersions by melt emulsification with a high disperse phase fraction.

The term “dispersion” is understood as meaning a multiphase system which comprises at least two components essentially insoluble in one another. Dispersions comprise on the one hand emulsions in which a liquid is present in dispersed form in the form of drops in another liquid. The phase which forms the drops is referred to as disperse phase or internal phase. The phase in which the drops are distributed is referred to as continuous phase or external phase.

On the other hand, dispersions comprise suspensions in which solid particles are dispersed in a liquid continuous phase. Moreover, substance systems which have both solid and also liquid phases in dispersed form are likewise types of dispersions. For example, a solid could be present in dispersed form in a first liquid, this suspension forming the disperse phase of an emulsion. In this connection, the term suspoemulsions is also used. Alternatively, solids may also be distributed in the continuous phase of emulsions.

The need for finely divided dispersions has increased considerably in recent years. When producing dispersions, it is important, to obtain an end product with the desired properties as regards size distribution of the disperse phase, the flow behavior and the stability of the product as regards thermal and mechanical stress and also changes over time, that the necessary steps for incorporating the internal phase into the external phase for producing a pre-mix, the fine dispersion and the stabilization of the resulting product are carried out in a manner which is defined and reliable in terms of processing. This gives firstly a coarse emulsion with low viscosity as preemulsion, also called pre-mix. By further introducing mechanical energy, the emulsion becomes finer and the viscosity increases. Industrially, dispersions, in particular emulsions, are produced by various processes. The process chosen depends on the type of dispersion and on the fineness of the disperse phase with which a dispersion that is stable over the required period can be obtained. A stable dispersion is understood as meaning a substance system whose particle size distribution and spatial distribution of the disperse phase and/or its flow behavior, in particular its viscosity, essentially does not change over a pre-given period as a result, for example, of sedimentation.

For the industrial production of dispersions, for relatively coarse dispersions, containers with a stirrer, for example a shaver stirrer or a stirrer turbine, are often used. For finer dispersions, two-stage processes are used in which firstly a preemulsion is prepared in a container with stirrer and then a pass through a rotor-stator machine takes place. This may be, for example, a colloid mill. Particularly fine dispersions can be achieved by carrying out the dispersion in a high-pressure homogenizer as an additional process step.

A further process for producing dispersions is melt emulsification. In the process of melt emulsification, the solid is melted to produce a finely divided suspension or emulsion, which can then be processed for example again to give a stable dispersion, and emulsified as melt. Processing times and energy expenditure are reduced here compared with other processes, but are in no way optimal. In addition, emulsifiers and protective colloid systems have to be found which must be stable and effective over a wide temperature range. These auxiliaries can hitherto only be found by complex trial and error methods and are a decisive cost factor in product development and production. In order to be able to produce very finely divided suspensions, very high temperatures have hitherto been required for the melt emulsification operation. The high temperature required for this frequently damages the ingredients. Moreover, the increased energy requirement constitutes an additional negative economic effect. The cooling process which follows the melt emulsification at a very high temperature involves considerably higher expenditure on apparatus and draws out the processing time. The expenditure is all the greater and the processing time all the longer if the process proceeds at very high temperatures.

US-A 2005/0031659 discloses oil-in-water emulsions prepared by melt emulsification which comprise a concentrated oil phase and a water-soluble emulsion formation polymer. The disperse oil phase is at least 50% by weight and up to 93% by weight. Preference is given to using oils and waxes which have a melting temperature below 100° C. The continuous phase also comprises water-soluble components such as glycerol and propylene glycol. The devices used for producing the oil-in-water emulsions are kitchen aids or ultra power mixers.

DE-A 10 2004 055 542 discloses a process for producing a finely divided emulsion from a crude emulsion. The crude emulsion is pressed through a porous membrane which is composed of two or more superimposed layers. Preference is given to using ultrafiltration and microfiltration membranes. The process is preferably used for shear-and temperature-sensitive substances.

U.S. Pat. No. 4,254,104 describes the production of an oil-in-water emulsion with an oil content of up to 90% oil which is diluted to the desired disperse phase fraction following production. The stabilization of the oil-in-water emulsion is achieved with nonionic emulsifiers. The droplet size distribution is below 1 μm. The emulsification is achieved with the help of homomixers and stirrers.

U.S. Pat. No. 5,670,087 describes the production of an oil-in-water emulsion by melt emulsification with bitumen as disperse phase at a production temperature of up to 100° C. and low shear of 10 to 1000 s⁻¹. It is disclosed that the emulsification takes place at a lower temperature than usual and thus even hard bitumen, i.e. bitumen (asphalt), which is characterized by a high softening point in combination with a low tendency toward moldability, can be produced, which cannot be produced using conventional processes. The droplet size distribution is between 2 and 50 μm. After producing the emulsion, dilution with water is optionally carried out.

U.S. Pat. No. 4,788,001 describes the production of an oil-in-water emulsion of highly viscous oils, in particular silicone oils, without use of heat for lowering the viscosity for a disperse phase fraction of at most 90%. The emulsification takes place with the help of stirring-mixing devices, as a result of which average droplet distributions between 0.5 and 1 μm are achieved.

It is a disadvantage of the processes from the prior art that there has hitherto been no economical process which allows a substance that is solid at room temperature to be converted to a finely divided suspension in an energy- and component-preserving manner at a temperature which is at most 10 K above the melting temperature of the substance solid at room temperature, via a finely divided emulsion, it being possible for said suspension to also have other liquids besides water as the continuous phase.

It is an object of the present invention to provide a process which makes it possible to produce a finely divided suspension from a substance with a melting temperature above room temperature, where the ingredients are preserved during the process and coalescence or aggregation is avoided or reduced.

The object is achieved through the provision of a process for the preparation of a finely divided suspension by melt emulsification, comprising at least one substance with a melting temperature above room temperature, comprising the following steps:

(a) passing at least one preemulsion, comprising one continuous phase and one disperse phase, to a rotor-stator machine, a rotor-rotor machine or to a continuous and/or disperse phase;

(b) optionally adding one or more further components to the at least one preemulsion in the rotor-stator machine;

(c) emulsifying the at least one preemulsion with mechanical shear and/or elongation and/or turbulence at a temperature which is at most 10 K above the melting temperature of the at least one substance with a melting temperature above room temperature, or at a temperature which is at least 10 K below and at most 10 K above the glass transition temperature or the melting temperature, if the substance with a melting temperature above room temperature is a polymer, for producing a finely divided emulsion;

(d) cooling the finely divided emulsion to produce a finely divided suspension;

where the disperse phase fraction at least in step (c) is in the range from 85% to 99.5%.

The melting temperature of a substance that is solid at room temperature is understood as meaning the temperature at which a substance which is solid at room temperature converts from the solid state to the liquid state through temperature input.

The glass transition temperature (T_{G}) is the temperature at which, for example, a polymer has the largest change in moldability. The glass transition separates the brittle energy-elastic range below it (=glass range) from the soft entropy-elastic range above it (=elastomeric region).

The advantages of the process according to the invention are that the ingredients are preserved by the temperature which only needs to be at most 10 K above the melting point of the substance solid at room temperature on account of the high disperse phase fraction, and at the same time energy is saved as the result of this low temperature.

It is also advantageous that as a result of the comparatively low temperature required for the melt emulsion process according to the invention, which is at most 10 K above the melting point of the substance solid at room temperature, a more rapid cooling to a range in which the suspension is stable against coalescence and/or aggregation, is possible. Moreover, such a melt emulsion process at a low temperature also opens up better selection options as regards emulsifiers which can be used.

The at least one predispersion from step (a) can be produced by predispersing at least one substance that is solid at room temperature and optionally auxiliaries in a continuous phase in a stirred reactor and then heating the at least one predispersion to a temperature, which is at most 10 K above the melting temperature of the at least one substance with a melting temperature above room temperature, or with the help of a static mixer with the continuous introduction of the disperse phase.

The at least one preemulsion from step (a) can also be provided by directly introducing a ground solid or a solid which is molten as the result of the input of temperature, to a continuous phase. The continuous phase can have room temperature or a temperature which, in the case of a mixture with the solid, is up to 10 K above the melting point of the at least one substance solid at room temperature. The continuous phase on its own can here have a considerably higher temperature. Thus, for example, polyethylene as disperse phase can be melted and added via a feed piece to, for example, water as continuous phase. The preemulsion produced in this way can then be transferred to a rotor-stator machine via a feed element.

The continuous phase used may be hydrophilic and liquid at room temperature.

However, liquids which have, for example, lipophilic character can also be used as continuous phase. For example, fluorinated or perfluorinated liquids and solvents can also be used. It is merely important that the phases are not miscible in one another even at high temperatures.

A rotor-stator machine is generally understood as meaning a homogenizing apparatus which is specifically used for producing emulsions.

Homogenization apparatuses are used for the mechanical mixing and stirring of several liquids that are not compatible with one another, for example water and oil, in order to homogenize these liquids to give an emulsion. They are often used in production devices for foods, chemical products or the like, experimental installations, etc. According to the prior art, homogenization apparatuses in a very wide variety of designs are known, including rotor-stator machines.

Rotor-stator machines are significantly more effective for dispersion purposes than, for example, disk stirrers, impeller stirrers or propeller stirrers. In a rotor-stator machine, the interrupted rotor is closely surrounded by an interrupted stator; an extremely high shear field is built up between the rotor and the stator. Moreover, several concentric rings are possible per rotor-stator unit.

The function principle of the rotor-stator essentially envisages the substance to be homogenized being sucked into a dispersion head in an axial direction, where it rotates it by 90° and conveys it through the slit in the rotor. The rotor rotates here with very high rotational speeds. The stationary stator likewise has slits through which the substance to be homogenized exits the rotor-stator machine.

In detail, a rotor-stator machine has a cylindrical stator fixed in a stirring chamber and a rotor arranged in a stator cavity, to which a speed is pre-given by a motor, where stator and rotor are provided with several radially designed flow channels. For example, two liquids which are not compatible with one another are conveyed into the cavity through a pump arranged separately from the rotor-stator machine. If, after introducing the liquids, the rotor starts to rotate, then a centrifugal force is supplied to the liquids, the liquids being expelled from the flow channels formed in the rotor, discharged into the gap between rotor and stator, and finally introduced into the radial flow channels of the stator. For effective homogenization of two or more liquids in a rotor-stator machine, it is thus important that a high shear force is supplied to the liquids entering the gap between rotor and stator. The stator does not rotate, but remains stationary, such that, as the rotor starts to rotate, a vortex flow is produced in the liquids located in the radial flow channels of rotor and stator. Further, a shear force is supplied according to the rotary speed to the liquids entering the gap between rotor and stator. As a result of the energy of the vortex flow and the shear force, the two liquids are homogenized and ultimately passed to the outside via the radial flow channels formed in the stator in the form of an emulsion.

Known rotor-stator machines are, for example, toothed-wheel dispersing machines with stirrers. In addition, there are colloid mills or high-pressure homogenizers.

In contrast to a rotor-stator machine, in the case of a rotor-rotor machine, instead of the stator, a rotor rotating at a second speed different from the speed of the first rotor is present. Moreover, rotor-stator machines and rotor-rotor machines correspond in design.

The individual process steps are described in detail below:

In process step (a), at least one previously prepared preemulsion, comprising in each case one continuous phase and one disperse phase, is passed preferably from a container to a rotor-stator machine or a rotor-rotor machine. This passing can take place via one or more feed elements, such as feed sections and/or feed tubes or feed hoses. Optionally, the feed is supported by pumps, superatmospheric pressure or subatmospheric pressure. The at least one previously prepared preemulsion comprising in each case one continuous phase and one disperse phase can, however, also be passed to another continuous phase or disperse phase or a mixture thereof. In addition, the at least one previously prepared preemulsion can be differently preheated.

If more than one preemulsion is used, these can be mixed with one another beforehand in a container and be passed to the rotor-stator machine as preemulsion mixture via a single feed.

However, it is also possible for each of the different preemulsions to be passed separately to the rotor-stator machine via their own feed element. The feed can take place in each case simultaneously or in succession depending on the preemulsion mixture.

In general, the passing of the at least one preemulsion can take place into the rotor-stator machine through continuous introduction via a feed element, or the passing of the at least one preemulsion takes place by discontinuous, phasewise introduction into the rotor-stator machine via a feed element.

In the optional process step (b), further components can be added to the at least one preemulsion passed previously to the rotor-stator machine. These further components can be selected from the group consisting of auxiliaries, such as emulsifiers, dispersion auxiliaries, protective colloids and rheology additives, and also further disperse phases.

These further components can be added in dissolved form or as solid to the rotor-stator machine with the at least one preemulsion located therein. The feed preferably takes place via any desired feed element known to the person skilled in the art.

In process step (c), the preparation of the finely divided emulsion takes place in the rotor-stator machine by emulsifying the at least one preemulsion with mechanical shear and/or elongation and/or turbulence at a temperature which is at least 10 K below and at most 10 K above the melting temperature of the at least one substance with the melting temperature above room temperature, or at a temperature which is at least 10 K below and at most 10 K above the glass transition temperature or of the melting temperature of the substance that is solid at room temperature if the substance with a melting temperature above room temperature is a polymer.

Preferably, the temperature during the emulsification is at most 2 K above the melting temperature of the substance that is solid at room temperature.

The temperature during the emulsification is particularly preferably at the level of the melting point of the substance that is solid at room temperature.

The emulsification can take place at various shear rates from 10³ to 10⁷ s⁻¹. The emulsification preferably takes place at a shear rate of 2.5×10⁴ to 2.5×10⁵ s⁻¹.

Rotor-stator machines which can be used are rotor-stator machines of the toothed-wheel dispersing machine type, colloid mill type or toothed-disk mill type.

The finely divided emulsion which is obtained at the end of process step c) preferably has a disperse phase fraction of from 85% to 99.5%.

The finely divided emulsion obtained by process step (c) can also be discharged directly and used directly in a further process.

In process step (d), the finely divided emulsion prepared previously is cooled by adding a further continuous phase heated below the melting temperature or the glass transition temperature of the substance that is solid at room temperature.

In one preferred embodiment, the finely divided emulsion prepared previously is diluted by adding a further continuous phase heated below the melting temperature or glass transition temperature of the substance that is solid at room temperature.

In one particularly preferred embodiment, the cooling takes place in process step d) at the same time as the dilution.

As a result, the finely divided emulsion is then converted into a finely divided suspension. Cooling with the preferably simultaneous dilution of the finely divided emulsion can take place by continuously or discontinuously introducing a colder phase via one or more feed elements. Preferably, the cooling and the preferably simultaneous dilution takes place continuously.

Preferably, the temperature of the further continuous phase is below the melting temperature of the disperse phase, but sufficiently high that the continuous phase produced upon cooling and dilution does not solidify.

Dilution can take place to a disperse phase fraction between 1 and 85%. In one preferred embodiment of the process according to the invention, cooling takes place with preferably simultaneous dilution in step (d) to an end concentration of disperse phase fraction of 1 to 70% by weight, preferably 20 to 70% by weight.

It is a further advantage that the finely divided emulsion in process step (d) can be diluted as desired in the course of cooling, but does not necessarily have to be diluted. As a result, it is possible to produce finely divided suspensions with quite different properties, as a result of which the process can be applied very broadly and flexibly. Cooling can likewise take place by means of external cooling elements or by adding a continuous phase with identical disperse phase fraction.

The cooling and/or dilution can take place in the rotor-stator machine or rotor-rotor machine, but also after discharge into an additional apparatus. The cooling and dilution can take place in succession or simultaneously. Preferably, the cooling and dilution take place simultaneously. As a result of the dilution, the coalescence and aggregate formation is reduced; in addition, it leads to more rapid cooling and better flowability at room temperature.

The process is usually followed by a discharge step. This discharge step can take place via customary discharge devices. The discharged finely divided suspension is passed to a collecting container or directly as constituent to a new process. This collecting container may be, for example, also a storage container. In the case of continuous circulation mode, instead of a collecting container feeding back to a rotor-stator machine or rotor-rotor machine can also take place.

The at least one substance whose melting point is above room temperature is the disperse phase.

In one particularly preferred embodiment of the process according to the invention, the at least one substance whose melting temperature is above room temperature is selected from the group consisting of waxes, fats, polymers and oligomers.

An oligomer is a molecule which is made up of two or more structurally identical or similar units. The precise number of units is open, but in most cases is between 10 and 30. Often, in the case of an oligomer, the starting point is a defined number of units, whereas polymers virtually always have a more or less broad molar mass distribution. Oligomers are in most cases technical precursors of polymers. Furthermore, it is possible to use substances comprising at least one crosslinkable polymer and a crosslinker, the melting temperature of the crosslinker being above the melting temperature of the polymer.

Examples of waxes are polymer waxes, PE waxes, long-chain alkanes, natural waxes, such as, for example, beeswax or carnauba wax.

Examples of fats are triglycerides, triacyl glycerides, synthetic fats.

Examples of polymers are thermoplastic polymers. Particular preference is given to using at least one thermoplastic polymer as polymer.

Thermoplastic polymers are understood as meaning plastics which can be easily shaped (thermoplastically) within a certain temperature range. This process is reversible, i.e. it can be repeated as often as desired by cooling and reheating to the melt-liquid state, provided decomposition of the material does not start as the result of overheating.

Thermoplastic polymers are, for example, polyolefins such as polyisobutene, polybutylene and polyethylene, polystyrene, polyvinyl chloride, polymethacrylate, cellulose acetate, cellulose acetobutyrate, and also all copolymers of polystyrenes, polyorganosiloxanes, polyamides and polyesters.

In one preferred embodiment of the invention, it is a process in which the at least one thermoplastic polymer is not based on petroleum.

In the process according to the invention, the continuous phases used in step (a) and (d) can be selected, independently of one another, from the group consisting of water, diethylene glycol, triethylene glycol, polyethylene glycol, propylene glycol, polypropylene glycol, polyetherols, glycerol, organic carbonates and carbonic acid esters. Preference is given to water, glycerol, polyetherols and organic carbonates. Particular preference is given to water, polyetherols and organic carbonates.

Organic carbonates which are used are particularly preferably ethylene carbonate and diethylene carbonate.

Moreover, auxiliaries and/or further components can also be used in the process according to the invention. Auxiliaries and/or further components which can be used in the process are also stabilization auxiliaries from the group of emulsifiers, dispersion auxiliaries, protective colloids and/or rheology additives.

The use of emulsifiers and emulsifiers themselves are generally known to the person skilled in the art.

The use of dispersion auxiliaries is generally known to the person skilled in the art.

Protective colloids are understood as meaning suspension agents which prevent the agglomeration of the droplets at the transition from the liquid state to the solid state. Examples of protective colloids for use in the present process according to the invention are amphiphilic polymers and also starch and starch derivatives.

Rheology additives is the term used to refer to substances which influence the flow behavior of the continuous phase. The rheology additives used are preferably thickeners.

Thickeners are substances which increase the viscosity of a medium, i.e. make it more viscous.

In a further embodiment of the invention, during the emulsification at high temperature (melt emulsification) in step (c), the disperse phase is comminuted into fine droplets and homogeneously dispersed, the fine droplets having an average drop size (the average distribution of the size of the drops produced during the process) which is in the range between 0.05 and 100 μm. The average drop size is particularly preferably in the range between 0.05 and 10 μm, in particular between 0.1 and 5 μm.

The process is usually followed by a discharge step. This discharge step can take place by means of customary discharge devices. The discharged, finely divided suspension is transferred to a collecting container or directly as constituent to a new process. This collecting container may be, for example, also a storage container. In the case of continuous circulation mode, instead of a collecting container, feeding back to a rotor-stator machine or rotor-rotor machine can also take place.

The feedback brings about a narrower particle size distribution and also better comminution of the preemulsion.

1. A process for the preparation of finely divided suspensions by melt emulsification, comprising at least one substance with a melting temperature above room temperature, comprising the following steps:
(a) passing at least one preemulsion, comprising one continuous phase and one disperse phase, to a rotor-stator machine, a rotor-rotor machine or to a continuous and/or disperse phase;
(b) optionally adding one or more further components to the at least one preemulsion in the rotor-stator machine;
(c) emulsifying the at least one preemulsion with mechanical shear and/or elongation and/or turbulence at a temperature which is at most 10 K above the melting temperature of the at least one substance with a melting temperature above room temperature, or at a temperature which is at least 10 K below and at most 10 K above the glass transition temperature or the melting temperature, if the substance with a melting temperature above room temperature is a polymer, for producing a finely divided emulsion;
(d) cooling the finely divided emulsion to produce a finely divided suspension;
where the disperse phase fraction at least in step (c) is in the range from 85% to 99.5%.

2. The process according to claim 1, wherein the finely divided emulsion produced above is diluted in step (d) by adding a further continuous phase heated to below the melting temperature or glass transition temperature of the substance that is solid at room temperature.

3. The process according to claim 1, wherein the cooling and dilution takes place simultaneously in process step (d).

4. The process according to claim 1, wherein the at least one substance whose melting temperature is above room temperature is selected from the group consisting of waxes, fats, polymers and oligomers.

5. The process according to claim 4, wherein at least one thermoplastic polymer is used as polymer.

6. The process according to claim 5, wherein the at least one thermoplastic polymer is not based on petroleum.

7. The process according to claim 1, wherein the continuous phases used in step (d) are selected, independently of one another, from the group consisting of water, diethylene glycol, triethylene glycol, polyethylene glycol, propylene glycol, polypropylene glycol, polyetherols, glycerol, organic carbonates and carbonic acid esters.

8. The process according to claim 1, wherein the auxiliaries and/or further components used are stabilization auxiliaries from the group of emulsifiers and/or dispersion auxiliaries and/or protective colloids and/or rheology additives.

9. The process according to claim 8, wherein the rheology additives are thickeners.

10. The process according to claim 1, wherein during the emulsification in step (b), the disperse phase is comminuted into fine droplets and homogeneously dispersed, the fine droplets having an average drop size which is in the range between 0.05 and 100 μm.

11. The process according to claim 3, wherein the simultaneous cooling and dilution takes place in step (d) to an end concentration of disperse phase fraction of 1 to 70% by weight.

12. The process according to claim 1, wherein the passing of one or more coarse predispersions and/or coarse preemulsions takes place directly prior to introduction into the rotor-stator machine in step (a) via a T-piece or an injector and the coarse predispersions and/or coarse preemulsions are thereby optionally differently preheated.
